(19) United States
(12) Patent Application Publication
(10) Pub. No.: US 2006/0272128 A1
(43) Pub. Date: Dec. 7, 2006

(54) Friction hinge with angularly dependent torque

(75) Inventor: Edward T. Rude, Columbia, MD (US)

Correspondence Address: GOTTLIEB RACKMAN & REISMAN PC, 270 MADISON AVENUE, 8TH FLOOR, NEW YORK, NY, 100160601, US

(73) Assignee: Torqmaster, Inc., Stamford, CT (US)

(21) Appl. No.: 11/341,254

(22) Filed: Jan. 26, 2006

Related U.S. Application Data
(60) Provisional application No. 60/687,483, filed on Jun. 4, 2005.

(51) Int. Cl. E05D 11/08

(52) U.S. Cl. 16/342

(57) ABSTRACT

A hinge assembly for providing variable angular dependant torque is provided. The hinge includes a band having at least one bearing segment and at least one variable torque segment. A shaft, rotatable within the band, has at least one bearing portion and at least one variable torque portion. The variable torque portion has a torque reducing surface and a torque producing surface. As the shaft rotates relative to the band, a resilient spring member on the band contacts the shaft along the torque producing surface to provide frictional torque and disengages from the shaft along the torque reducing surface in order to reduce frictional torque.

This application claims priority of Provisional Application Ser. No. 60/687,483, filed Jun. 4, 2005.

### BACKGROUND TO THE INVENTION

This invention relates to friction hinge mechanisms used for mounting displays, video screens, and other devices which require precise angular positioning to minimize reflections and to optimize the viewing angle. The word display will be used to characterize all such devices as well as other elements needing rotatable positioning. A smaller torque is often desired for moving the display into position, and a larger torque is desired for maintaining the best position for viewing it. Pop-up mechanisms are often used to facilitate opening displays from their closed positions. And frictional torque sufficient to hold the display in position for viewing usually interferes with the operation of the pop-up mechanism, making a lesser torque very desirable for that angular portion of the hinge's motion.

The hinge of our invention can provide very small torques for part of the hinge's rotation, and large torques for other parts of the rotation, in almost any pattern that is desired. The transitions between angular regions of different torques can be abrupt or smooth, as needed. Additionally, one or more detent positions can be designed into the hinge.

The inventive hinge can be arranged to provide almost any profile of torsional friction versus deployment angle.

### BRIEF DESCRIPTION OF THE INVENTION

This invention is based on the development of frictional torque between a shaft and one or more bands. The shaft is configured to produce friction where required and free movement where minimal friction is required. Detents can also be provided. The bands are usually, although not necessarily, of metal that is formed into a shape generally recognizable as that of a question mark. The curved part of the question-mark band has two cuts, separating that part of the band into three portions. A shaft is fitted into the band. In the preferred embodiment, the two end portions of the divided band are formed with circular cross-sections. The shaft is also divided into three portions, the ones on each end being round and having the same diameter as the inside diameter of the end portions of the divided band. These end portions of the shaft and band comprise bearings to keep the axis of the shaft from moving while the shaft is rotated. The center portions of both the band and the shaft are configured to provide the desired torque and detent characteristic of the inventive hinge, as will be described below.

In the simplest embodiment of our invention, only one band is used, but the extension to more than one band will be obvious to those skilled in the art.

In particular, a single band of steel in the shape of a question mark, with a flat portion for mounting and a curved portion into which a shaft is fitted, is provided. The curved portion is partially divided into thirds by two cuts made perpendicular to the axis of the curved portion. The outer two portions form a bearing. This bearing maintains the centerline of the shaft and is a slip fit. In the basic version of the invention, these outer parts of the hinge are only intended to be a set of bearings, and they are not intended to produce any friction, although it is possible to conceive of applications in which some level of friction may be desired. In that case, there could be some interference between the outer parts of the band and the shaft. Between these two outer band sectors is a third sector. This third sector has a spring portion having a contour such that some portion of it extends within the radius of the end portions of the shaft. The length of the shaft that is surrounded by the band sector incorporating the spring has a shape which is obtained by the selective removal of shaft material. When the original radius of the shaft is juxtaposed by the spring, there will be frictional resistance to rotation. When the reduced radius of the shaft is juxtaposed by the spring, there will be reduced friction or even no friction.

In a further embodiment, the shaft has at least one local groove. The spring then has a rounded shape which engages the groove. This arrangement produces friction during shaft rotation until the groove aligns with the rounded spring shape. This produces a detent action. Another embodiment incorporates both a non-friction shaft sector in addition to a detent feature. Thus, one can produce frictional torque in one or more sectors, no torque in other sector(s), and a detent or detents at some other angular position(s).

In the preferred embodiment, there will be two outer bearing sectors with a center spring sector. However, this could be reversed, having two outer spring sectors and a center bearing sector. Symmetry is surely desirable but not essential. It is also conceivable that the two bearing sectors be oppositely wrapped. The essential features of the invention are that a single sheet metal component maintains the centerline of the shaft (one does this with the two bearing sectors) and produces, as desired, variations in frictional torque, which are obtained at various angular positions between the shaft and band. This includes torsional friction, no friction, detent action, snap closed actions (a variant of detent), and various transitions between these modes.

It is an object of our invention to provide a friction hinge having different levels of torque at different angular positions of the shaft relative to the band.

It is a further object of our invention to furnish a friction hinge having detent capability in addition to the various levels of torque at various angular positions.

It is a still another object of our invention to provide a friction hinge that is capable of holding an electronic display firmly in a closed position and, upon release, is easily moved into a range of positions for optimum viewing while providing sufficient torque to maintain any such position.

It is an additional object of our invention to provide a friction hinge having low torque for the stored position of the display and yet capable of providing a holding torque sufficient to maintain the optimum viewing angle of the display even when subjected to the movement of a vehicle on a bumpy road.

The inventive friction hinge with an angularly dependent torque accordingly comprises the features of construction, combination of elements, and arrangement of parts which will be exemplified in the constructions described hereinafter, and the scope of the invention will be indicated in the claims.

### DESCRIPTION OF THE DRAWINGS

FIG. 1 is a view of the rear of a laptop computer in order to show a possible use of a pair of our inventive hinges and how they might be employed.

FIG. 2 shows the same laptop from the front with the display in the open position as it might be for viewing.

FIG. 3 is an enlarged front view of the laptop of FIG. 2 and shows one of the inventive hinges (the right hinge) and how it may be used to connect the lid of the laptop to the base.

FIG. 4 is a rear perspective view of the right hinge.

FIG. 5 is a rear view of the left hinge showing where cross-sections A-A and B-B are taken.

FIG. 6 is a cross-sectional view of the left hinge taken at A-A as indicated in FIG. 5.

FIG. 7 is a cross-sectional view of the left hinge taken at B-B as indicated in FIG. 5, in which the angular position of the hinge is in a range configured to produce friction.

FIG. 8 is a cross-sectional view of the left hinge taken at B-B as indicated in FIG. 5 in which the angular position of the hinge is in a range configured to produce little or no friction.

FIG. 9 is a cross-sectional view of the left hinge taken at B-B as indicated in FIG. 5 in which the angular position of the hinge is in the transition from a region having friction to one with little or no friction.

FIG. 10 is a rear perspective view of an alternative embodiment of the hinge, from which one of the bearing segments has been omitted for clarity, with the depicted hinge having a detent in addition to the other features of the invention and the hinge depicted in the detent position.

FIG. 11 is a rear perspective view of yet another embodiment of the invention in which the central portion of the segmented band is the bearing, and the two outer sections are the segments providing friction where needed and also having one or more detents as required.

### DETAILED DESCRIPTION OF THE DRAWINGS

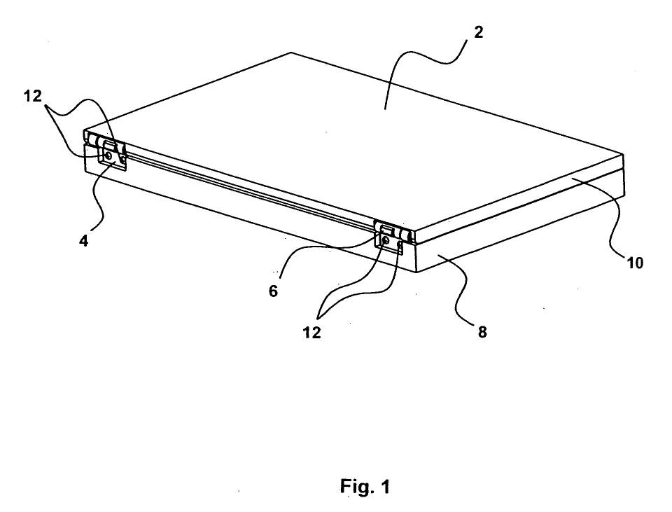

Referring to FIG. 1, a rear view of laptop 2 is shown with hinges 4 and 6 that are used both to join base 8 to lid 10, and to provide the torque needed to angularly position lid 10 with respect to base 8 for optimal viewing of the laptop screen. Screws 12 are used to fasten hinges 4 and 6 to base 8. Although two screws are shown for each hinge, in practice, any convenient arrangement of fasteners could as well be used.

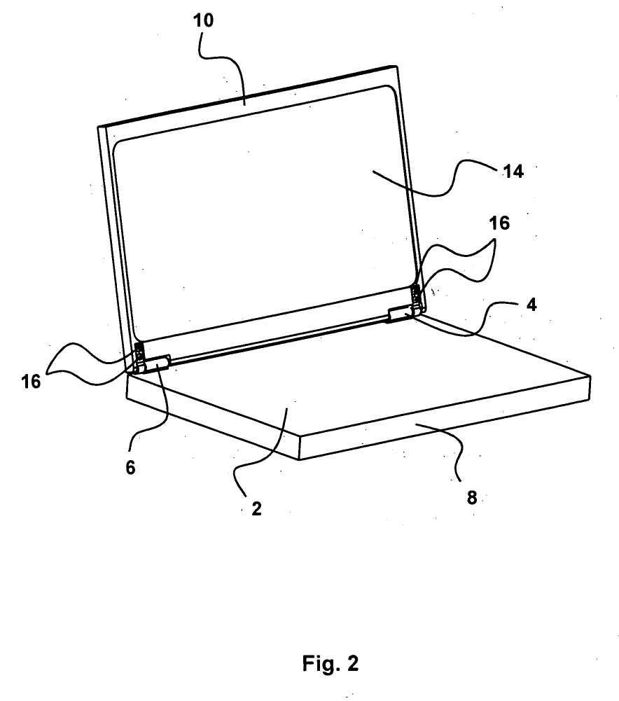

In FIG. 2, lid 10 of laptop 2 is open and held in position by the hinges for viewing of screen 14. The hinges are fastened to lid 10 by screws 16, for which any convenient substitution could be made.

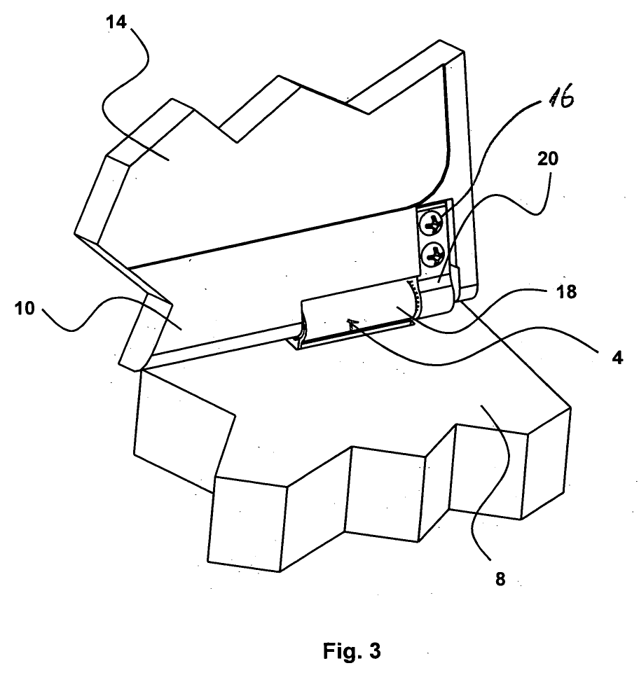

Right hand hinge 4 is shown in FIG. 3 from the front with band 18 and adapter 20 connected respectively to base 8 and lid 10.

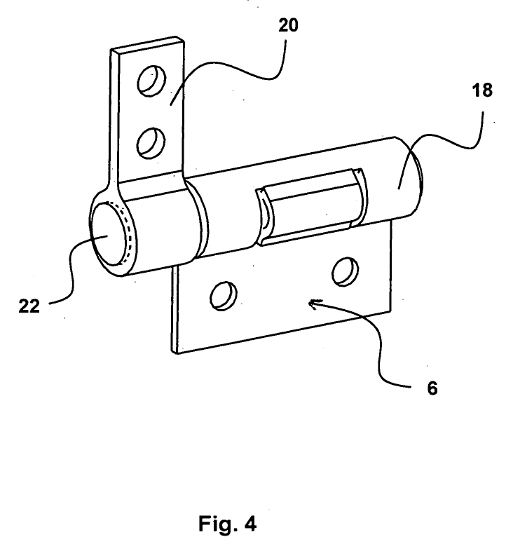

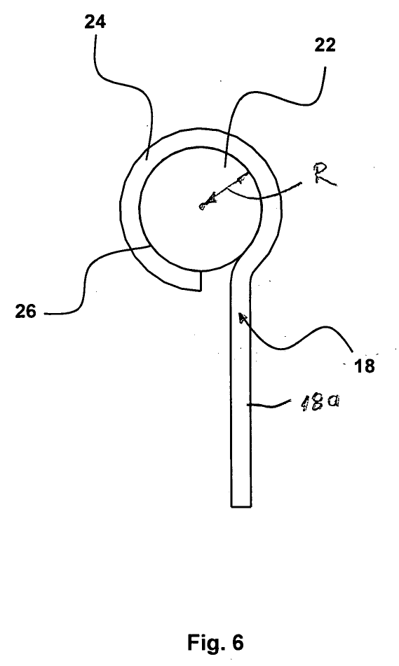

Hinge 4 is seen in FIG. 4 from the rear. Adapter 20 is irrotatably affixed to the end of shaft 22 by means of a press fit, or by any other convenient method. Shaft 22 is inserted into the question-mark portion of band 18 (see, e.g., FIG. 6).

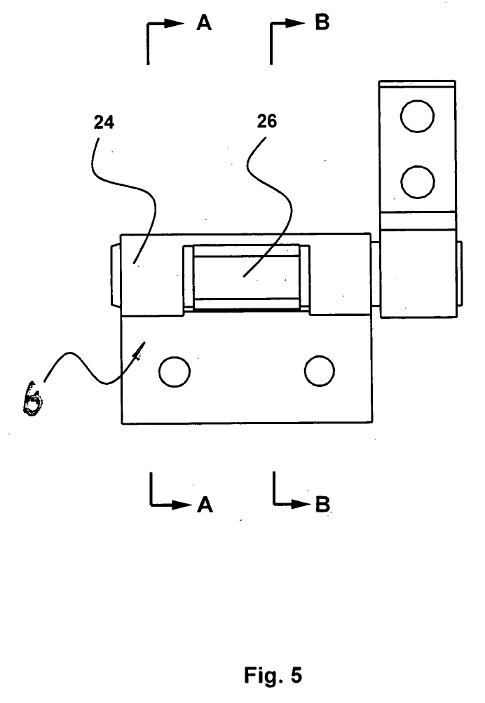

FIG. 5 shows left hinge 6 with cross-section A-A taken through end bearing portion 24 of the hinge, and cross-section B-B taken through center portion 26 of the hinge.

In FIG. 6, cross-section A-A shows the circular shapes of band 18 and shaft 22 in the bearing portions of the hinge. The band has a generally “question mark” shape defined by the arcuate bearing portion 24 and the longer band portion 18a. Where little or no frictional torque is required for some part of the hinge's angular travel, the bearing portions of both the inside diameter of band 18 and the diameter of shaft 22 would be the same. As an alternative, the hinge can provide some baseline torque throughout its range of motion by making the band's inside diameter 26, in the bearing portions of the hinge, somewhat smaller than the shaft size. This will produce a torque according to the principles well know to those skilled in the art of friction hinges.

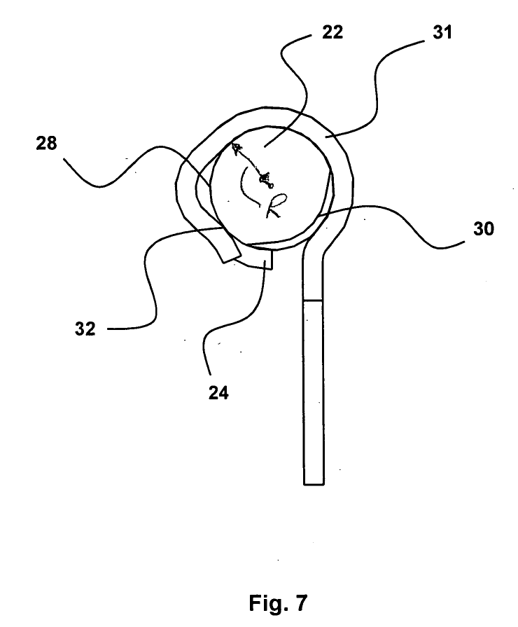

Cross-section B-B, shown in FIG. 7, depicts the center portion of the hinge in a position to produce torque. Herein, shaft 22 has a portion of its circumference 28 at the full shaft diameter, being possibly as large as the diameter 26 (see FIG. 6) at the end bearing portion of the shaft, and a portion of the shaft's diameter at a reduced diameter 30 to reduce or eliminate the torque produced by contact with the center portion of band 18. The center portion of band 18 is circular except near its end where it is curved so as to produce line contact with the shaft at 32. The band material, ordinarily steel, should be hardened to have good spring characteristics. Care must be taken to avoid any burr or sharp edge on contact line 32 that could cause damage to the shaft where the contact pressures are large. In the preferred embodiment shown here, that is accomplished by a slight outward bend, directing the end of the band slightly away from the shaft. Alternatively, the end of the band could be carefully rounded, but this is usually more expensive to accomplish. The center portion of the band is formed so that there is pressure between the full diameter of the shaft and the band at the line of contact 32. In FIG. 7, the line of contact 32 between the band and the shaft is in the arcuate portion of the shaft that is at the full diameter, producing, thereby, a torque whose value depends upon the thickness of the band material and the interference between the shaft's full diameter and the center portion of the band, as well as on the other factors usually involved in the dynamics of such contact. In other words, the shaft provides an arcuate surface defined by the same radius, R, as the radius of the shaft at its bearing portion (see, FIG. 6).

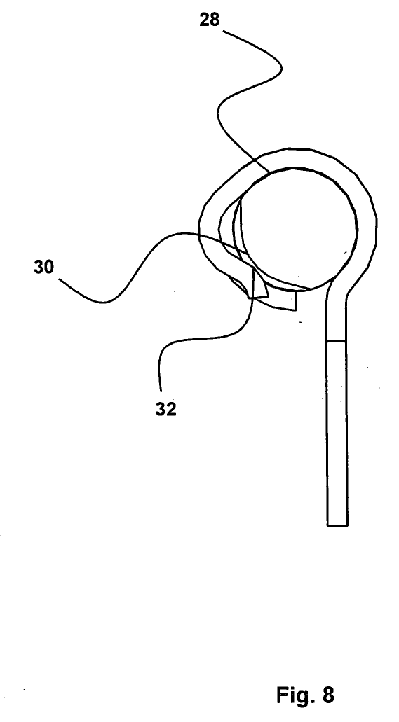

As the shaft rotates to the position shown in FIG. 8, line of contact 32 moves over the reduced shaft diameter 30 where it looses contact with the center portion of the shaft, and the torque disappears. At this position, the shaft diameter is reduced so that it defines a surface (which may or may not be arcuate), but in any case is less than the radius R of the shaft at the “full” diameter.

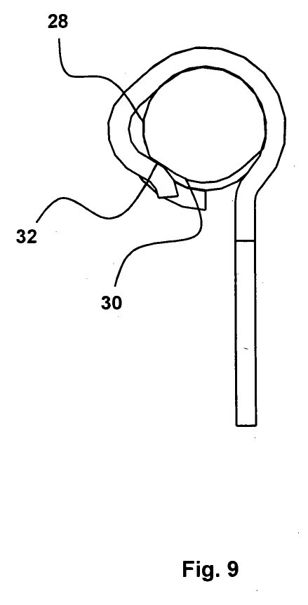

Thus, at the cross-sections depicted in FIG. 8 and in FIG. 9, shaft 22 provides a variable torque portion defining a torque producing surface 28 and a torque reducing surface 30. Likewise, band 18 at the depicted cross-sections, provides a variable torque portion defined by shaft contacting member 32 which, as mentioned, advantageously has a spring characteristic. As shaft 22 rotates relative to band 18, shaft contacting member 32 produces frictional torque as this member makes contact with torque producing surface 28. On the other hand, shaft contacting member 32 provides reduced torque as the shaft contacting member reaches torque reducing surface 32, since the contacting member disengages from contact with shaft 22 as the shaft is rotated relative to band 18.

FIG. 9 shows the shaft positioned to put line of contact 32 at the transition between the reduced diameter 30 and the full diameter 28. By properly configuring this transition, it can be made gradual or abrupt, according to the needs of the hinge application.

Obviously, the angular extents of the full torque segment and the reduced torque segment of the shaft can be configured as needed. There can also be more than one region of full and reduced torques, again as needed.

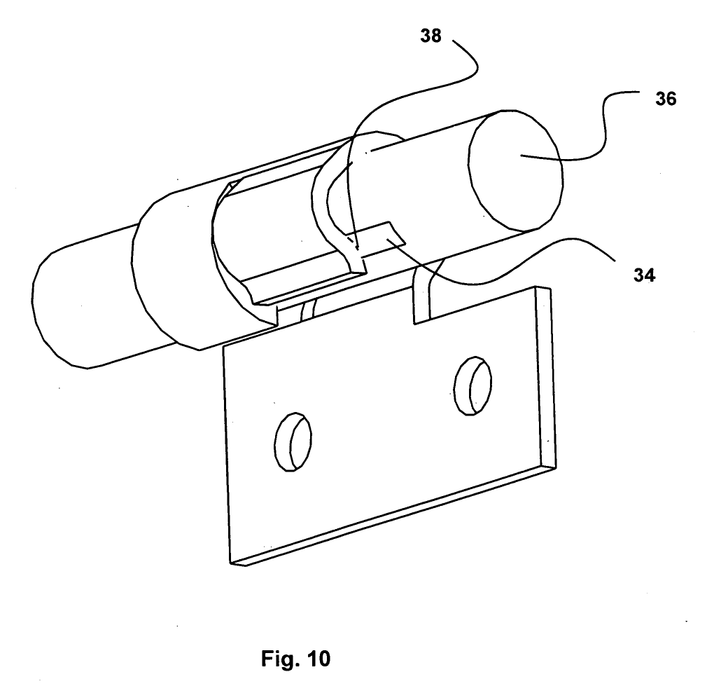

An alternative embodiment of the invention is depicted in FIG. 10. Groove 34 is formed in shaft 36 to form a detent position into which line of contact 38 moves. The strength of the detent will, as with the torque, depend on the thickness of the band material. It will also depend on the depth and detailed shape of the detent groove. There can be multiple detent grooves if desired.

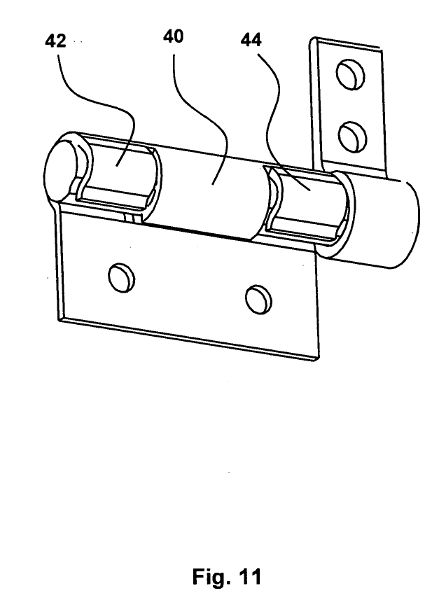

FIG. 11 shows a hinge with the same operational characteristics as the hinge of the preferred embodiment. But in this embodiment, there is only one bearing portion 40 in the center of the hinge, and two friction-producing portions 42 and 44 on the ends. This embodiment has the advantage of having more length in the friction-producing parts of the hinge. This permits achieving the same friction at reduced pressure, or of producing more friction at the same pressure as in the earlier design. A disadvantage of this arrangement is that, in having only one bearing, the alignment of the shaft and the band will not be as good.

It is to be understood that the description of the invention as set forth above is with reference to illustrative embodiments, and that changes may be made in the invention described above without departing from the spirit and scope of the invention, which are set forth in the following claims.

What is claimed is:

1. A hinge assembly for providing variable angularly dependant torque comprising:
a band having at least one bearing segment and at least one variable torque segment;
a shaft rotatable along an axis with respect to said band, said shaft having at least one bearing portion and at least one variable torque portion, said shaft bearing portion disposed within said band bearing segment and said shaft variable torque portion disposed within said band variable torque segment;
said shaft variable torque portion having a torque producing surface and a torque reducing surface;
said band variable torque segment having a shaft contacting member for selectively contacting said shaft;
wherein as said shaft rotates relative to said band, said shaft contacting member contacts said shaft along said torque producing surface to provide frictional torque and disengages from contacting said shaft along said torque reducing surface in order to reduce frictional torque.

2. A hinge assembly according to claim 1, wherein said shaft contacting member is a resilient spring member.

3. A hinge assembly according to claim 1, wherein said shaft torque producing surface comprises an arcuate surface.

4. A hinge assembly according to claim 1, wherein said shaft has a radius extending from said axis and said shaft torque producing surface is defined by said radius.

5. A hinge assembly according to claim 4, wherein the transverse distance from the axis of said shaft to said shaft torque reducing surface is less than said radius.

6. A hinge assembly according to claim 5, wherein said shaft bearing portion is defined by an arcuate surface.

7. A hinge assembly according to claim 6, wherein said shaft bearing portion is defined by said radius.

8. A hinge assembly according to claim 2, wherein as said shaft rotates relative to said band, said resilient spring member makes selective line contact with said shaft at said shaft torque producing surface.

9. A hinge assembly according to claim 2, wherein said shaft torque reducing surface comprises a groove formed in said shaft.

10. A hinge assembly according to claim 9, wherein said resilient spring member has a rounded element which selectively engages said groove.

11. A hinge assembly according to claim 10, wherein as said resilient spring member engages said groove, a detent is provided between said shaft and said band.

12. A hinge assembly according to claim 1, wherein said shaft variable torque portion of said shaft further includes a transition surface disposed between said torque producing surface and said torque reducing surface.

13. A hinge assembly according to claim 1, wherein said band has two bearing segments and said shaft has two bearing portions.

14. A hinge assembly according to claim 13, wherein said band variable torque segment is disposed between said band bearing segments and said shaft variable torque portion is disposed between said shaft bearing portions.

15. A hinge assembly according to claim 1, wherein said band has at least two variable torque segments and said shaft has at least two variable torque portions.

16. A hinge assembly according to claim 15, wherein said band bearing segment is disposed between said band variable torque segments and said shaft bearing portion is disposed between said shaft variable torque portions.

17. A hinge assembly according to claim 1, wherein said band has a curved portion for receiving said shaft and a flat portion for mounting said hinge.

18. A hinge assembly according to claim 17, wherein said band curved portion comprises said bearing segment and said variable torque segment.
